(19) United States
(12) Patent Application Publication
(10) Pub. No.: US 2011/0289823 A1
(43) Pub. Date: Dec. 1, 2011

(54) METHOD OF AND APPARATUS FOR APPLYING A PESTICIDE

(75) Inventor: Allen Alford, Bedford, TX (US)

(73) Assignee: FIRE ANT ASSASSIN, LLC, Kansas City, MO (US)

(21) Appl. No.: 13/092,264

(22) Filed: Apr. 22, 2011

Related U.S. Application Data
(60) Provisional application No. 61/326,699, filed on Apr. 22, 2010.

(51) Int. Cl. A01M 7/00

(52) U.S. Cl. 43/124

(57) ABSTRACT

A method and apparatus for applying a pesticide to an ant mount involving pushing the discharge end of a wand down into the mound to a level generally corresponding to a bottom of the mound, discharging pesticide, and filling the mound in a generally upward direction until the mound collapses on itself. The apparatus has a container, an aspirator having first and second inlets and an outlet, a flow regulator for regulating the flow of fluid from a source of pressurized fluid to the first inlet of the aspirator, a flexible fluid flow line connecting the container and the second inlet of the aspirator, and a wand connected to the outlet of the aspirator for discharging a mixture of pesticide and pressurized fluid from the wand.

### REFERENCE TO RELATED APPLICATION

The present invention claims priority to U.S. provisional application 61/326,699 filed Apr. 22, 2010, the entire disclosure of which is expressly incorporated herein by reference.

### FIELD OF THE INVENTION

The present invention generally relates to the application of pesticides, and more particularly to the application of pesticides to ant mounds, such as those populated by fire ants.

### BACKGROUND OF THE INVENTION

Fire ants have been particularly difficult to eradicate. Various methods to eradicate these pests have been used, such as those described in U.S. Pat. Nos. 5,054,231, 5,881,493, 6,755,400 and 5,870,852, but none have proven to be particularly effective. This is due at least in part because many of the prior methods involve the application of pesticide to the exterior surface of an ant hill before an attempt is made to apply the pesticide to the interior of the mound. (The “hill” is that portion of a “mound” that is above normal ground level. The “mound” is the entire physical structure above and below ground.) As a result, ants inside the mound (including the queen ant or ants) have time to move to areas where they survive the application. Further, even in those cases where a probe/wand is inserted into the mound, the probe/wand is not used in a manner which prevents the escape of many of the ants, including one or more queen ants.

### SUMMARY OF THE INVENTION

This invention is directed to a method of applying a pesticide. The method comprises the following steps, in sequence: inserting a discharge end of a wand into an ant mount having a dry exterior surface; pushing the discharge end of the wand down into the mound to a level generally corresponding to a bottom of the mound; initiating a discharge of pesticide through the discharge end of the wand after the wand has been pushed down to at least said level; and continuing the discharge to fill the mound from said level in a generally upward direction.

Apparatus of this invention comprises a container for containing a supply of pesticide, an aspirator having first and second inlets and an outlet, a flow regulator for regulating the flow of fluid from a source of pressurized fluid to the first inlet of the aspirator, a flexible fluid flow line connecting the container and the second inlet of the aspirator, and a wand connected to the outlet of the aspirator for discharging a mixture of pesticide and pressurized fluid from the wand.

Other objects and features will be in part apparent and in part pointed out hereinafter.

### BRIEF DESCRIPTION OF THE DRAWINGS

FIG. 1 is a view showing the inside of an ant mound and, schematically, a wand of an apparatus of this invention inserted in the mound for application of a pesticide in accordance with a method of this invention;

FIGS. 2-7 are photos showing the apparatus and various components of the apparatus;

FIG. 8 is a longitudinal section taken through an aspirator of the apparatus;

FIGS. 9-13 are additional photos showing various components of the apparatus; and

FIG. 14 shows an ant mound under a slab, and a wand, shown schematically, inserted in the mound for application of a pesticide in accordance with a method of this invention.

Corresponding reference characters indicate corresponding parts throughout the drawings.

### DESCRIPTION OF THE PREFERRED EMBODIMENTS

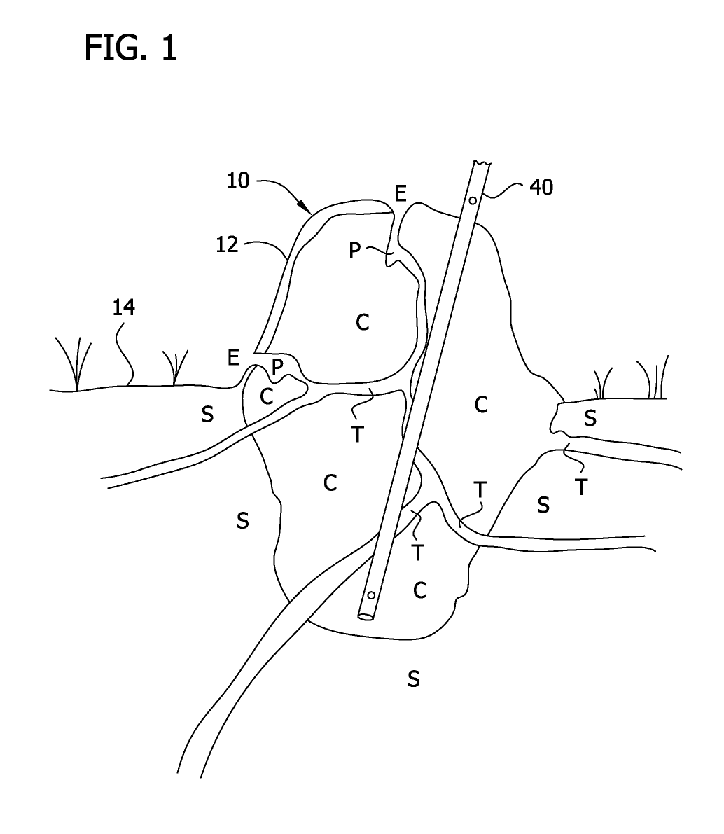

The present invention is directed to a method and apparatus for applying a pesticide to an ant mound, such as an ant mound populated by fire ants. FIG. 1 illustrates the construction of one such ant mound, generally indicated at 10. The “hill” portion of the mound 10 has a generally conical exterior surface 12 which extends up from a surrounding ground surface 14 and tends to crust over in dry weather. The mound is made of loose friable particles of earth, sand and other material loosely packed compared to the surrounding ground and having a texture similar to the texture of coffee grounds, for example. The mound 10 contains a network of tunnels T having entrances/exits E leading to various interconnected chambers C forming subterranean dwellings for a colony of ants, including one or more queen ants. The tunnels extend down and laterally outward into the ground surrounding the mound to provide routes for foraging and travel between the mound and satellite ant mounds. Some of the underground tunnels T also provide avenues of quick escape for the queen(s) when the mound 10 is disturbed. Each tunnel is typically formed with a pocket P adjacent entrances/exit E of the tunnel. The pocket catches rainwater and holds it for time sufficient to collapse and block the entrance/exit opening to prevent flooding of the mound.

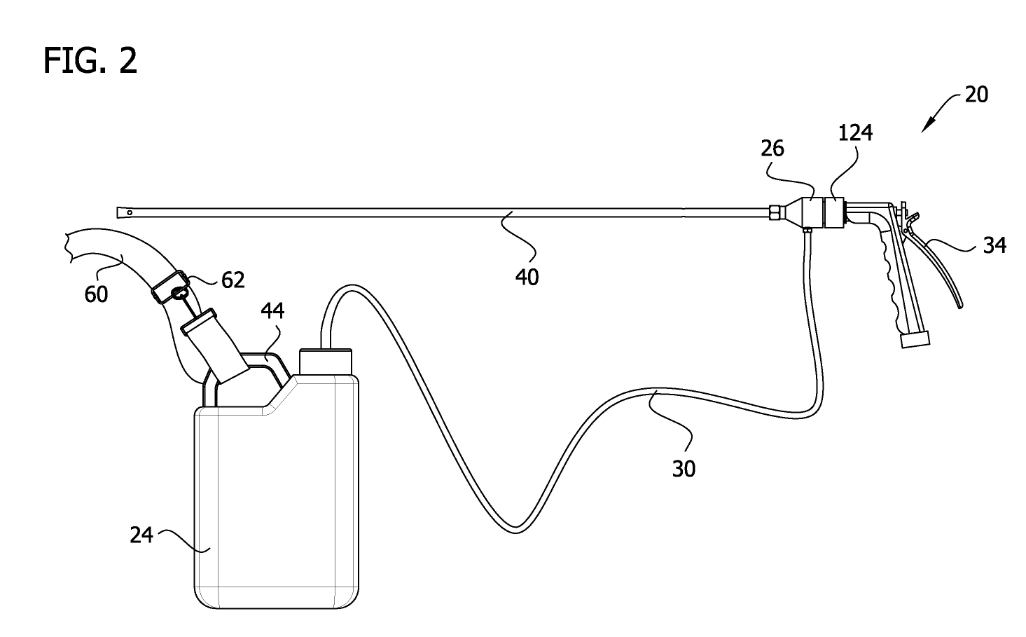

FIG. 2 illustrates exemplary apparatus 20 for applying a pesticide to the ant mound in accordance with a method of this invention. In general, the apparatus comprises a container 24 for containing a supply of pesticide, an aspirator 26, a flexible fluid flow line 30 connecting the container and the aspirator, and a flow regulator 34 for regulating the flow of fluid from a source of pressurized fluid to the aspirator. A wand 40 is connected to the aspirator 26. The wand has a longitudinal axis and one or more discharge ports for discharge of pesticide from the wand. These components are described in more detail below.

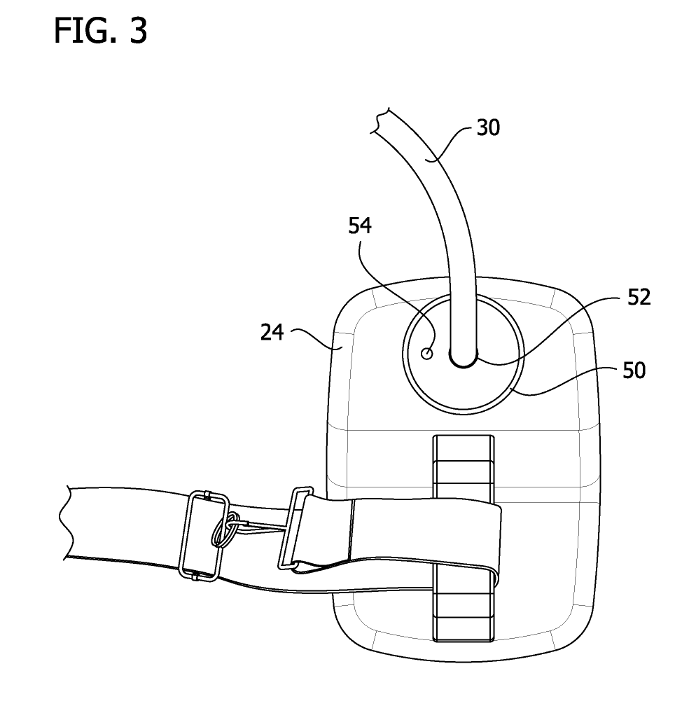

As shown in FIGS. 2-3, the container 24 comprises a jug having a handle 44, a spout defining an opening, and a cap 50 threaded on the spout for closing the opening. As shown in FIG. 3, the cap has two holes 52, 54 in it, one (52) for receiving the fluid flow line 30 and the other (54) for venting the jug. The jug has a suitable capacity, e.g., 0.25 to 5.0 gallons. Other types of containers are within the scope of this invention. Cartridges or screw-on bottles of various sizes and shapes, for example, may be used.

Referring to FIGS. 2-4, the jug 24 is attached to a carrier which, in this embodiment, comprises a shoulder strap 60 or sling which can be worn over a shoulder of the person dispensing the pesticide. The length of the shoulder strap is adjustable by a buckle 62. An end of the shoulder strap loops through a handle opening 66 on the jug 24 and is secured in place by a clip 68 on the strap having a releasable connection with a ring 70 on the buckle 62. Desirably, the attachment of the jug 24 to the shoulder strap 60 in this manner allows the jug to pivot relative to the shoulder strap and thus remain upright during use. Further, the connection and the flexibility of the fluid flow line 30 allow the wand 40 to be readily moved to virtually any orientation between vertical and horizontal, as required when applying pesticide to ant mounds at different locations, e.g., in the open and under slabs. Other types of containers, carriers and container-carrier connections are within the scope of this invention.

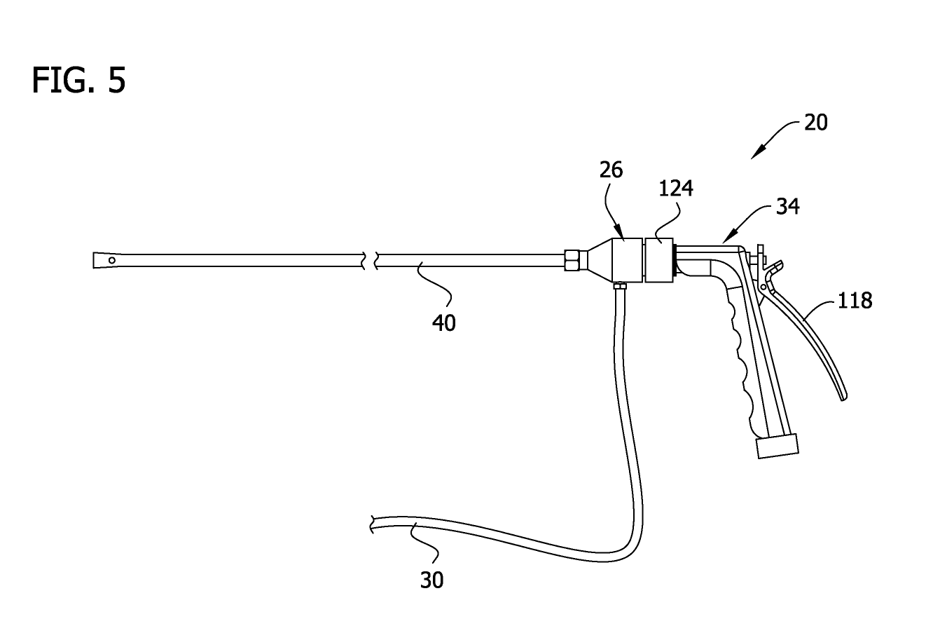

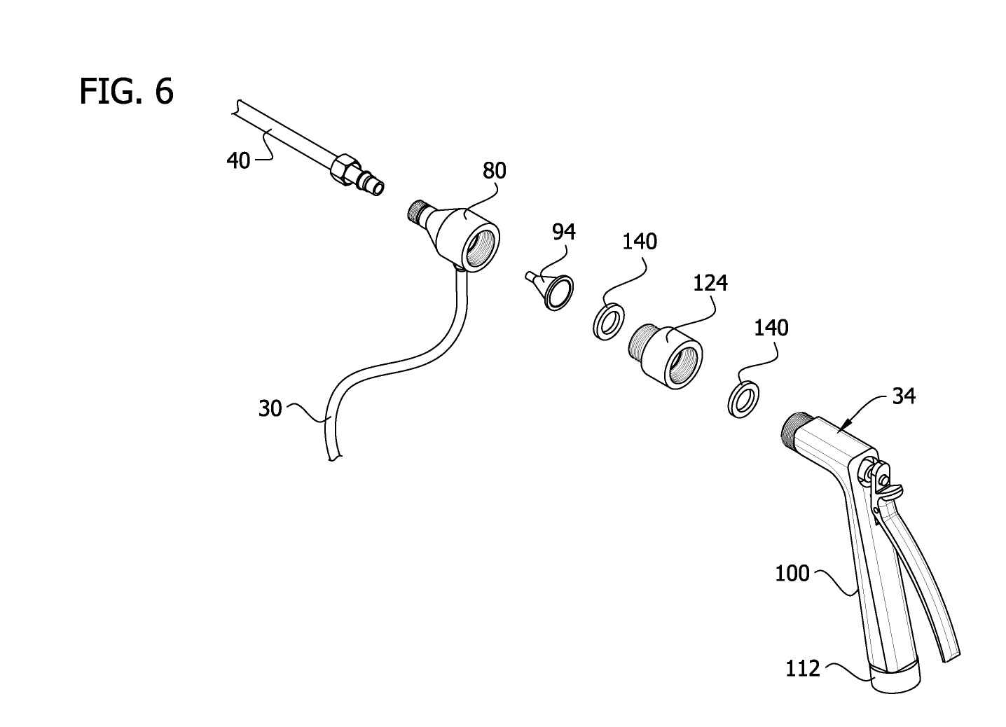

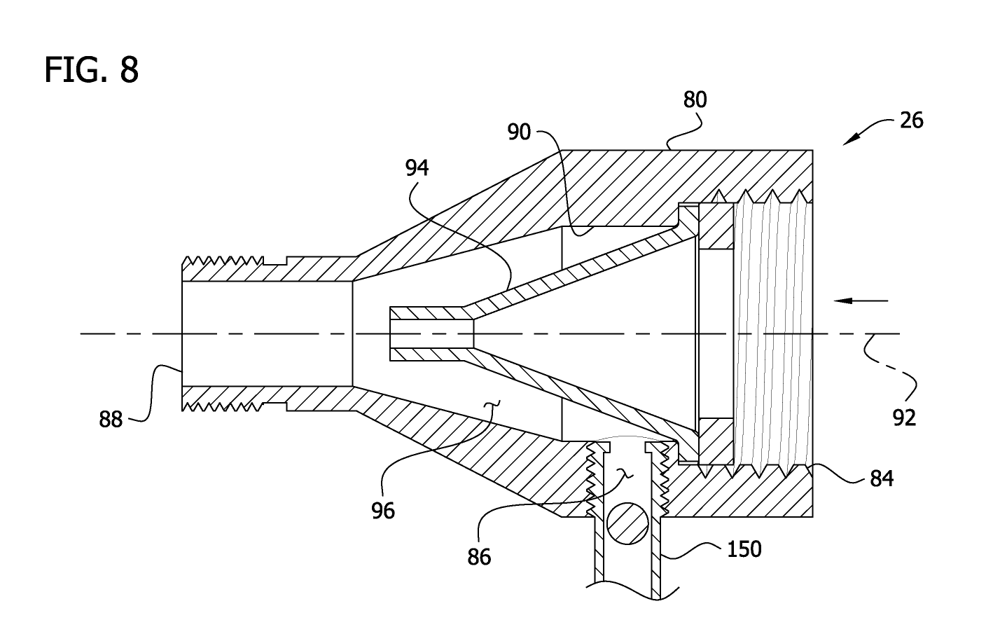

Referring to FIGS. 5-8, the aspirator 26 comprises an aspirator body 80 having a first inlet 84 for releasable (e.g., threaded) connection to the flow regulator 34, a second inlet 86 for releasable connection to an outlet end of the pesticide flow line 30, and an outlet 88 for releasable (e.g., threaded) connection to an inlet end of the wand 40. As illustrated in FIG. 8, the body 26 of the aspirator has bore 90 through it extending along an axis 92 from the first inlet 84 to the outlet 88. A funnel-shaped nozzle 94 is supported in this bore 90. The nozzle 94 has relatively wide upstream end for receiving fluid under pressure from the first inlet 84 and tapers to a narrower downstream end for discharge of the fluid under pressure into the wand 40. The nozzle 94 is spaced from the inside surface of the aspirator body 80 defining the axial bore 90 to create an annular flow path 96 from the second pesticide inlet 86 to the outlet of the aspirator body. As will be understood by those skilled in the art, the movement of pressurized fluid through the nozzle 94 creates a negative pressure or suction (due to the venturi effect) at the second inlet 86 to draw pesticide from the jug 24. The pesticide mixes with the water at the downstream end of the aspirator body as it enters the wand 40 to form a fluid mixture or solution of water and pesticide. The amount of water mixed with the pesticide can vary. For convenience, this fluid mixture is hereinafter referred to simply as “pesticide.”

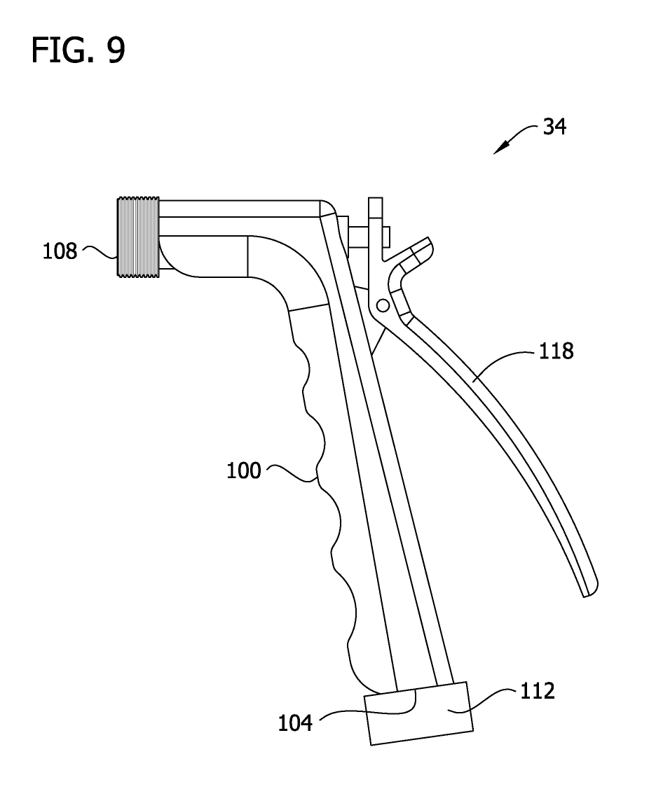

Referring to FIG. 9, the flow regulator 34 comprises a regulator body 100 having a pistol-grip shape. A fluid passage (not shown) extends from an inlet end 104 of the regulator body to an outlet end 108 of the regulator body. A swivel connector 112 is rotatable on the inlet end 104 of the body for threaded (releasable) connection of the body to a source of pressurized fluid such as a hose (not shown) attached to a residential or commercial water supply. A shut-off valve (not shown) is provided in the flow passage through the regulator body and is movable between fully-open and fully-closed positions by actuating a lever 118 pivoted on the body 100. The rate of flow can be controlled by pivoting the actuating lever to selected positions, which causes the shut-off valve to move to different (partially open) positions between fully-open and fully-closed positions. The pistol-grip body 100, shut-off valve and actuating lever 118 are of conventional design and will not be described in detail.

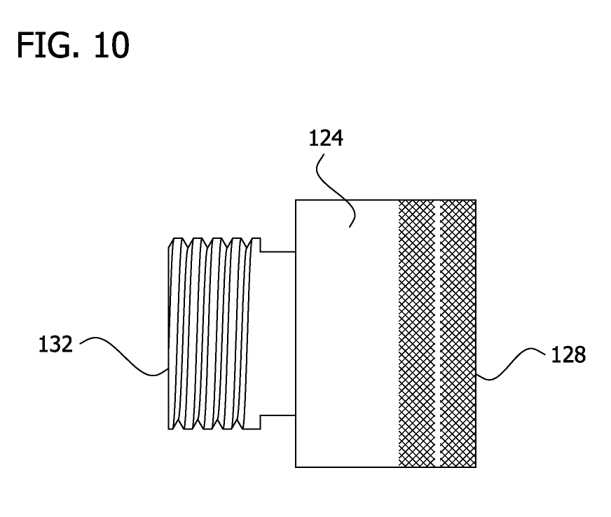

Referring to FIGS. 5, 6 and 10, the outlet end 108 of the regulator body 100 is connected to the first inlet 84 of the aspirator body 80 by an adaptor 124 having a flow path through it which is generally co-axial with the axis 92 of the aspirator body. The adaptor 124 has an inlet end 128 with internal threads which mate with external threads on the regulator body 100 and an outlet end 132 with external threads which mate with internal threads in the bore 90 (FIG. 8) of the aspirator body 80 at its first inlet 84. Gaskets 140 are provided for sealing these connections. The adaptor 124 may incorporate a check valve (not shown) for preventing back flow.

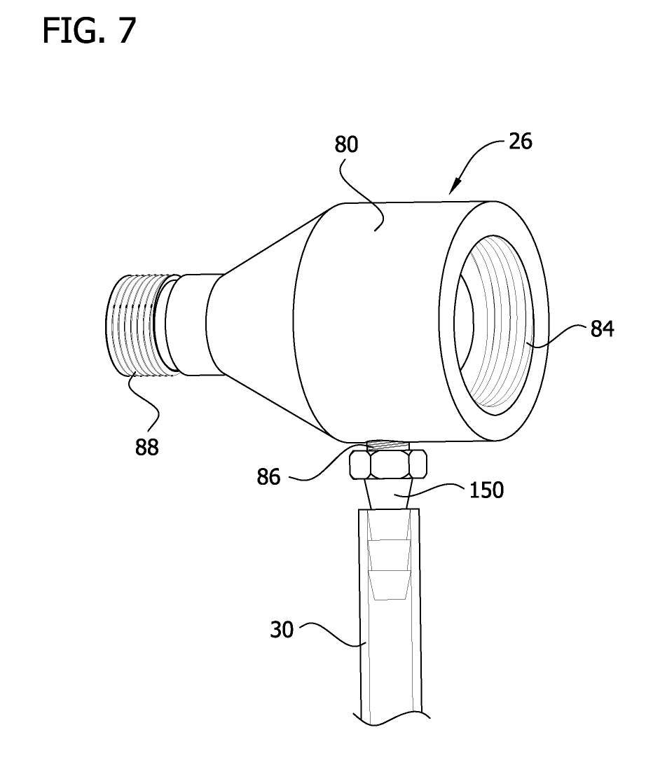

The fluid flow line 30 comprises tubing, desirably flexible tubing, of any suitable material which is strong, durable and chemically inert to the pesticide being used. By way of example, the tubing may be clear plastic tubing which allows visual observation of the fluid flow through the tubing. As shown in FIG. 3, the inlet end portion of the line 30 extends through the opening 52 in the cap 50 on the jug 24 and contains a strainer (not shown). The outlet end of the line is connected to the second inlet 86 of the aspirator body 80 by means of a barbed fitting 150 (FIGS. 7 and 8) extending generally at right angles to the longitudinal axis 92 of the aspirator body.

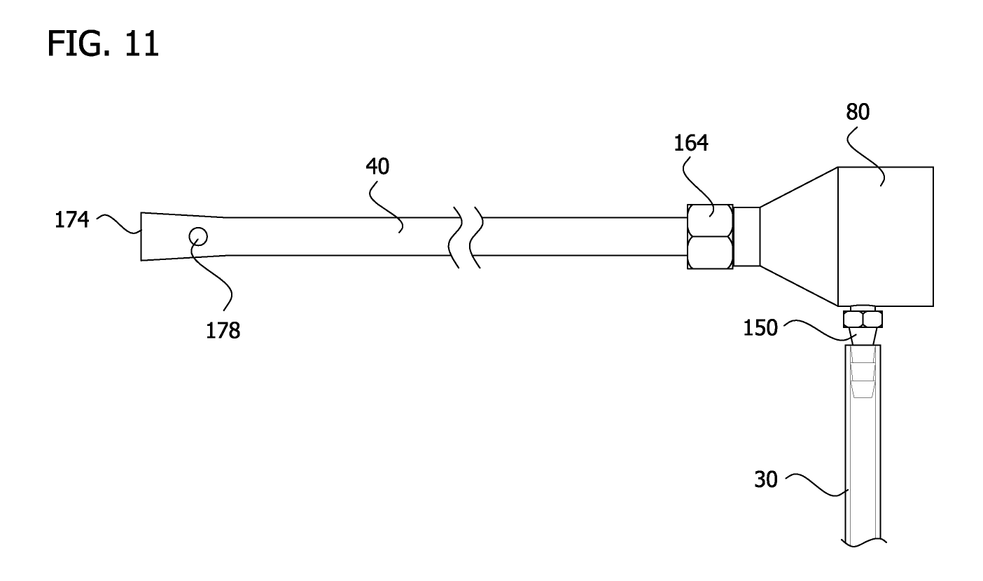

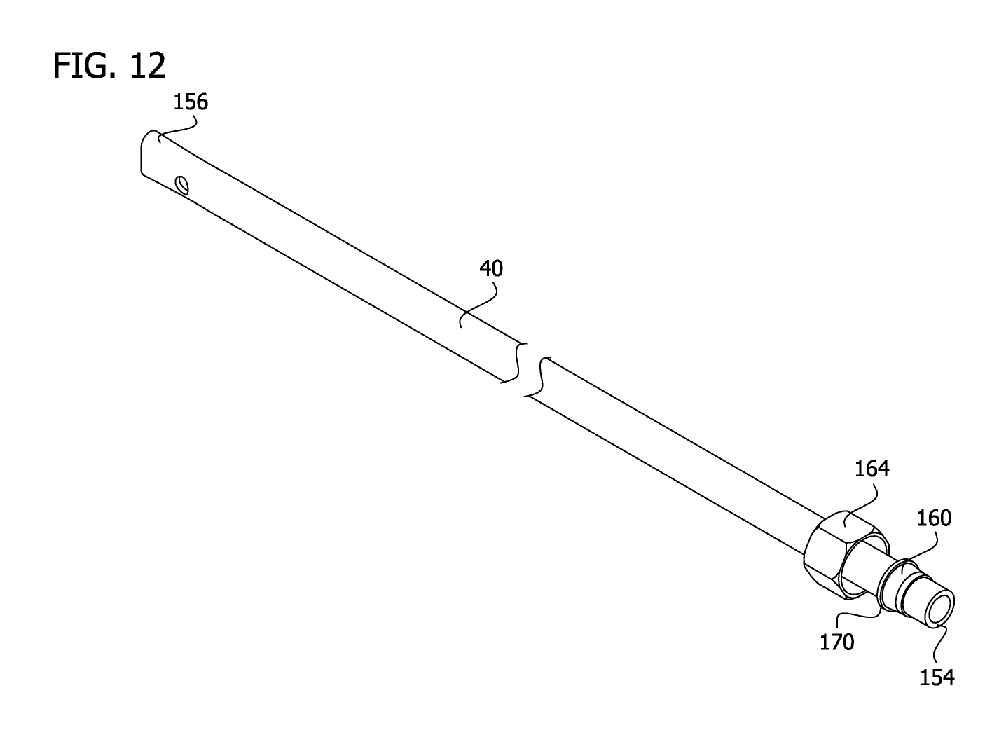

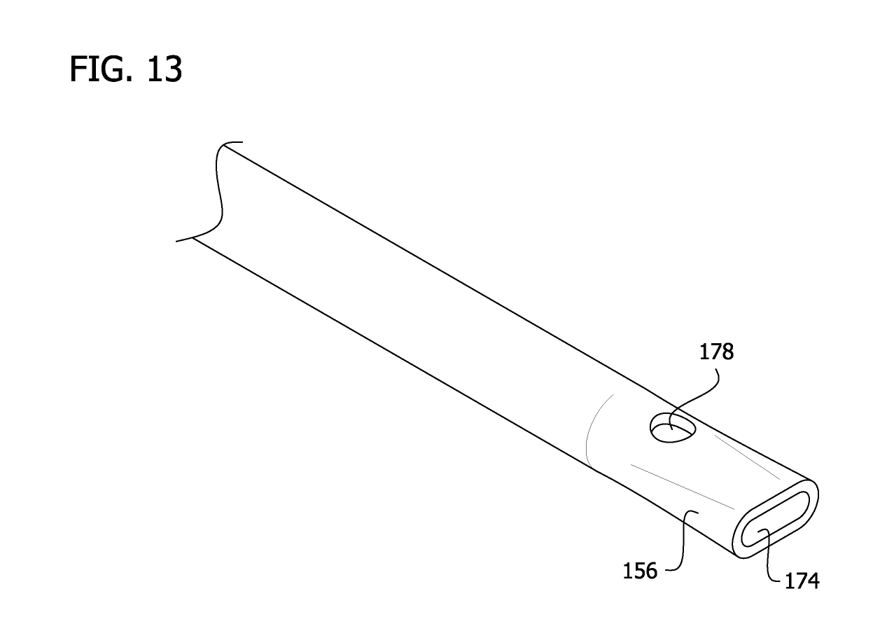

Referring to FIGS. 11-13, the wand 40 comprises an elongate tube having an upper inlet end 154 and a lower discharge end 156. The releasable connection between the inlet end of the wand and the outlet 88 of the aspirator body 80 comprises a ferrule 160 affixed to the wand and a nut 164 surrounding the tube and rotatable relative to the tube and ferrule. The nut has an internal shoulder (not shown) which engages a radial flange 170 on the ferrule and internal threads which mate with external threads on the aspirator body 80 to create a fluid-tight seal. Desirably, the longitudinal axis of the wand 40 is generally coincident with the longitudinal axis 92 of the aspirator 26 when the two components are connected. The wand 40 is of a suitable material such as a stainless steel.

The wand is of suitable length (e.g., three feet) and diameter (e.g., 0.25 in. ID). (For convenience of illustration, the length of the wand shown in the photos is reduced.) One or more discharge ports are provided at the lower discharge end 156 of the wand for discharging pesticide from the wand. In the illustrated embodiment, the wand has an open lower end forming an end discharge port 174 for discharging pesticide along the longitudinal axis of the wand. The wand also has at least one and preferably two or more diametrically opposed openings 178 in the side wall of the tube forming side discharge ports spaced a relatively short axial distance (e.g., 0.5 in.) from the end discharge port. An end portion of the tube is flattened to narrow the end discharge port 174 to facilitate penetration of the wand through the crusted exterior surface of an ant hill, and to reduce plugging or clogging of the port as the wand is pushed into the mound. Desirably, the end and side discharge ports 174, 178 are configured to direct fluid in a fan/arrowhead pattern in a substantially forward direction away from the end of the tube. As will be explained, this pattern is effective to create a turbulent flow which facilitates rapid flooding of the ant mound when the wand is inserted into the mound. The pattern is also effective for saturating the exterior surface of the ant hill without wetting the person applying the pesticide. Desirably, the discharge from the end and side ports is not substantially sideways to avoid wetting the person using the apparatus. The number and location of the discharge ports can vary within the scope of this invention.

When the above components are assembled, the flow path from the outlet end 108 of the flow regulator 34 to the end discharge port of the wand 174 lies extends along the same longitudinal axis. This arrangement facilitates use of the apparatus.

The apparatus of this invention is suitable for use with any type of liquid pesticide. One desirable pesticide comprises a pesticide having foaming characteristics.

The apparatus 20 described above can be used to apply pesticide in the following manner. The aspirator 26, flow regulator 34, fluid flow line 30 and wand 40 are connected as described above; the flow regulator is connected to a source of fluid under pressure (e.g., a residential or commercial water line); the jug 24 is filled with pesticide (typically in concentrated form); and the cap 50 is applied to the spout 46 with the fluid flow line extending down into the jug so that the inlet end of the line is adjacent the bottom of the jug. The apparatus 20 is now ready for use.

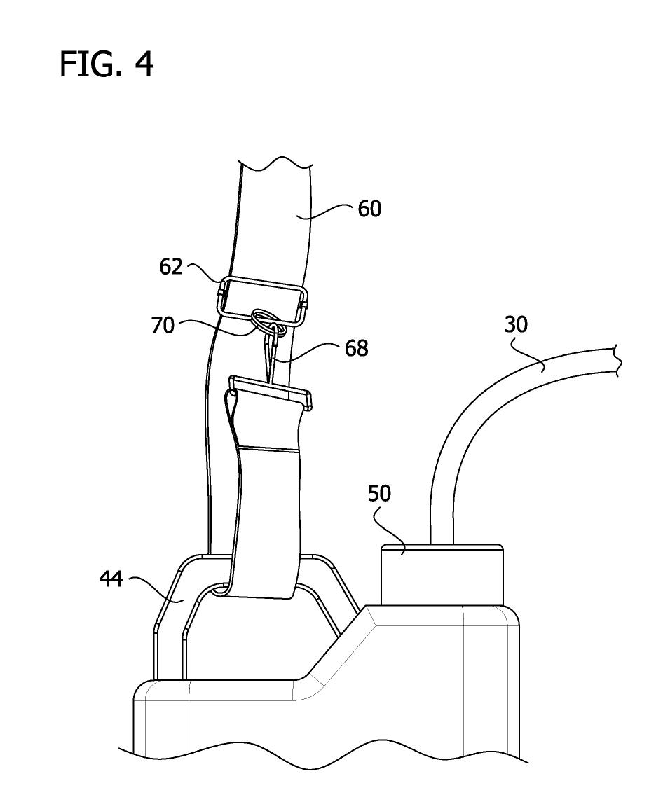

Referring to FIG. 4, the application process is initiated by inserting (forcibly pushing) the discharge end of the wand 40 into the hill portion of an ant mound having a dry exterior surface. As used herein, the term “dry” means that the “hill” of the mound has not been wetted with pesticide immediately prior to insertion of the wand into the mound. It is preferable to avoid such wetting because the very act of wetting and accompanying movement around the ant hill is likely to warn the colony of ants inside the mound and provide ample opportunity for many ants to escape, including the queen ant or ants.

After initial penetration of the wand through the exterior crust of the hill portion of the mound, the wand 40 is immediately pushed down to a location or level generally corresponding to the bottom of the mound. In this regard, the discharge end of the wand will move relatively easily through the loose particles of the mound until the wand contacts the unexcavated ground surface at the bottom of the mound. At this point, resistance to further downward movement of the wand increases, thus signaling the person applying the pesticide that the bottom of the mound has been reached. The wand is then pulled back a selected, relatively short distance (e.g., about one inch to the position shown in FIG. 1) and the actuating lever 118 on the flow regulator 34 is immediately moved to open the shut-off valve. This allows fluid under pressure and pesticide to flow through the aspirator and wand for discharge at a high rate through the end and lateral discharge ports of the wand. The insertion process should be carried out as quickly as possible (e.g., 2-5 seconds or less).

Discharge of the fluid into the mound in downward and outward directions will cause turbulence and rapid flooding of the mound from the bottom up. As a result, the ants have little time to escape and there is less risk that the person applying the pesticide will be splattered with mud, ants and other debris. It also helps ensure rapid, robust delivery of the pesticide to the area of the mound inhabited by the queen or queens. Further, the turbulent flow and filling from the bottom up can cause the mound to collapse. After filling, the wand is slowly withdrawn from the mound while continuing the flow of the pesticide through the discharge ports. The withdrawal should be sufficiently slow that the entire ant mound and perimeter areas are flooded.

After flooding is complete, the flow of fluid is reduced and the wand removed from the mound. The exterior surface of the hill and surrounding ground is then saturated with pesticide mixture to complete the process.

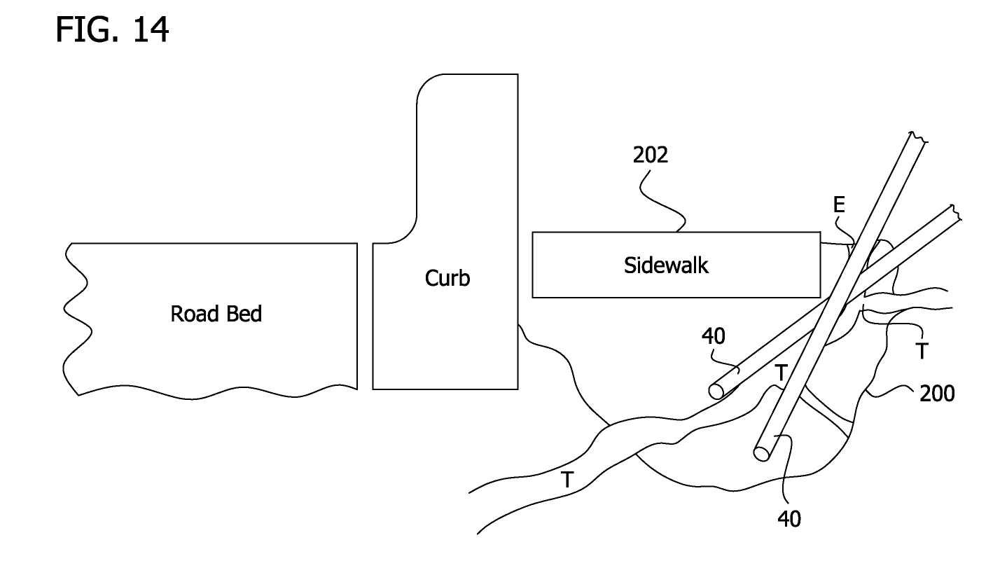

FIG. 14 shows an ant mound 200 located under a slab 202, which may be a walkway, driveway, porch, street, curb, etc. Because the top of the mound is not accessible, the wand 40 will be inserted into the mound at a more horizontal angle. Two exemplary angles are shown schematically in FIG. 14. The same process described above is used for applying the pesticide to a mound under a slab. During this process, there is no leakage of pesticide from jug because the jug 24 remains substantially upright due to its pivotal connection with the shoulder strap. Further, the flexibility of the fluid flow line 30 and the rotatable (swivel) connection 112 between the water supply hose 114 and the flow regulator 34 allows the wand 40 to be conveniently oriented at virtually any angle necessary for the proper application of pesticide to the mound.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of applying a pesticide, comprising the following steps, in sequence:
inserting a discharge end of a wand into an ant mound having a dry exterior surface;
pushing the discharge end of the wand down into the mound to a level generally corresponding to a bottom of the mound;
initiating a discharge of pesticide through the discharge end of the wand after the wand has been pushed down to at least said level; and
continuing said discharge to fill the mound from said level in a generally upward direction.

2. A method as set forth in claim 1, further comprising connecting said wand to a source of unpressurized liquid pesticide and to a source or pressurized fluid, mixing the pesticide and pressurized fluid to provide a pesticide mixture, and delivering said pesticide mixture under pressure to the wand.

3. A method as set forth in claim 1, wherein said wand has a central longitudinal axis, and wherein the pesticide is discharged generally downward in an arrowhead/fan pattern.

4. A method as set forth in claim 2, wherein said pushing step comprises pushing the wand down until substantial resistance is encountered corresponding to the discharge end of the wand contacting the bottom of the mound.

5. A method as set forth in claim 2, further comprising pulling the wand up a selected distance from the bottom of the mound before initiating said discharge.

6. A method as set forth in claim 5, wherein said selected distance is about one inch.

7. A method as set forth in claim 1, wherein said pesticide is a foaming pesticide.

8. A method as set forth in claim 1, further comprising withdrawing the wand from the mound after the mound has collapsed, and then saturating an exterior surface of the mound.

9. A method as set forth in claim 1, wherein said mound is populated by fire ants.

10. The method of claim 1 wherein the discharge of pesticide is performed with an apparatus for applying a pesticide to an ant mound, comprising
a container for containing a supply of pesticide,
an aspirator having first and second inlets and an outlet,
a flow regulator for regulating the flow of fluid from a source of pressurized fluid to the first inlet of the aspirator,
a flexible fluid flow line connecting the container and the second inlet of the aspirator, and
a wand connected to the outlet of the aspirator for discharging a mixture of pesticide and pressurized fluid from the wand.

11. The method of claim 10 wherein the aspirator comprises an aspirator body having a bore extending along a longitudinal axis from the first inlet to said outlet, and wherein said wand has a longitudinal axis generally coincident with the longitudinal axis of the aspirator body.

12. The method of claim 10 wherein said wand has an end discharge port for discharging pesticide mixture along the longitudinal axis of the wand, and at least one side discharge port spaced from the end discharge port.

13. The method of claim 12 wherein said end and side discharge ports are configured for discharging the pesticide mixture in a generally arrowhead/fan pattern in a downward direction.

14. The method of claim 10 wherein said flow regulator comprises a regulator body having an inlet and an outlet connected by a flow passage, and a swivel connector rotatable on the body for threaded connection to a hose connected to said source of pressurized fluid.

15. The method of claim 10 wherein the apparatus further comprises a carrier for carrying said container, said carrier having a pivot connection with said container whereby the container is able to remain upright during application of the pesticide.

16. Apparatus for applying a pesticide to an ant mound, comprising
a container for containing a supply of pesticide,
an aspirator having first and second inlets and an outlet,
a flow regulator for regulating the flow of fluid from a source of pressurized fluid to the first inlet of the aspirator,
a flexible fluid flow line connecting the container and the second inlet of the aspirator, and
a wand connected to the outlet of the aspirator for discharging a mixture of pesticide and pressurized fluid from the wand.

17. Apparatus as set forth in claim 16, wherein the aspirator comprises an aspirator body having a bore extending along a longitudinal axis from the first inlet to said outlet, and wherein said wand has a longitudinal axis generally coincident with the longitudinal axis of the aspirator body.

18. Apparatus as set forth in claim 16, wherein said wand has an end discharge port for discharging pesticide mixture along the longitudinal axis of the wand, and at least one side discharge port spaced from the end discharge port.

19. Apparatus as set forth in claim 18, wherein said end and side discharge ports are configured for discharging the pesticide mixture in a generally arrowhead/fan pattern in a downward direction.

20. Apparatus as set forth in claim 16 wherein said flow regulator comprises a regulator body having an inlet and an outlet connected by a flow passage, and a swivel connector rotatable on the body for threaded connection to a hose connected to said source of pressurized fluid.

21. Apparatus as set forth in claim 16, further comprising a carrier for carrying said container, said carrier having a pivot connection with said container whereby the container is able to remain upright during application of the pesticide.
